(19) United States
(12) Patent Application Publication
(10) Pub. No.: US 2009/0130517 A1
(43) Pub. Date: May 21, 2009

(54) SOLID ELECTROLYTE MEMBRANE, METHOD AND APPARATUS OF PRODUCING THE SAME, MEMBRANE ELECTRODE ASSEMBLY, AND FUEL CELL

(75) Inventors: Hiroshi Miyachi, Kanagawa (JP); Ryo Takeda, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/994,878

(22) PCT Filed: Jul. 5, 2006
(86) PCT No.: PCT/JP2006/313798

§ 371 Date: Jan. 7, 2008

(30) Foreign Application Priority Data
Jul. 7, 2005 (JP) 2005-198365
Mar. 29, 2006 (JP) 2006-089821

(51) Int. Cl. H01M 8/10; B28B 1/14

(52) U.S. Cl. 429/30; 425/470; 264/336

(57) ABSTRACT

A dope (24) containing a solid electrolyte is cast from a casting die (81) onto a running belt (82). A casting membrane (24a) is peeled from the belt (82) as a wet membrane (25) containing the solid electrolyte. The wet membrane (25) is sent to a tenter drier (64) and dried therein to have a predetermined width in a state that both side edges thereof are held with clips (64a). The wet membrane (25) is then sent out of the tenter drier (64) as a membrane (62). The membrane (62) is sent to a drying chamber (69) and is further dried while being supported by rollers (68).

### TECHNICAL FIELD

The present invention relates to a solid electrolyte membrane, a method and an apparatus of producing the solid electrolyte membrane, and a membrane electrode assembly and a fuel cell using the solid electrolyte membrane. The present invention especially relates to a solid electrolyte membrane having excellent proton conductivity used for a fuel cell, a method and an apparatus of producing the solid electrolyte membrane, and a membrane electrode assembly and a fuel cell using the solid electrolyte membrane.

### BACKGROUND ART

A lithium ion battery and a fuel cell that are used as a power source for portable devices have been actively studied in recent years. A solid electrolyte used for the above mentioned battery or cell is also actively studied. The solid electrolyte is, for instance, a lithium ion conducting material or a proton conducting material.

The proton conducting material is generally in the form of a membrane. The solid electrolyte in membrane form, which is used as a solid electrolyte layer of the fuel cell and the like, and its producing method have been proposed. For instance, Japanese Patent Laid-Open Publication No. 9-320617 discloses a method of producing a solid electrolyte membrane by immersing a polyvinylidene fluoride resin in a liquid in which an electrolyte and a plasticizer are mixed. Japanese Patent Laid-Open Publication No. 2001-307752 discloses a method of producing a proton conducting membrane by synthesizing an inorganic compound in a solution containing an aromatic polymer compound with the sulfonic acid group, and removing a solvent therefrom. In this method, oxides of silicon and phosphoric acid derivative are added to the solution in order to improve micropores. Japanese Patent Laid-Open Publication No. 2002-231270 discloses a method of producing an ion-exchange membrane. In this method, metal oxide precursor is added to a solution containing an ion-exchange resin, and a liquid is obtained by applying hydrolysis and polycondensation reaction to the metal oxide precursor. The ion-exchange membrane is obtained by casting the liquid. Japanese Patent Laid-Open Publication No. 2004-079378 discloses a method of producing a proton conducting membrane. In this method, a polymer membrane with a proton conductivity is produced by a solution casting method. The membrane is immersed in an aqueous solution of an organic compound soluble to water and having a boiling point of not less than 100° C., and is allowed to swell to equilibrium. Water is then evaporated by heating. In this way, the proton conducting membrane is produced. Japanese Patent Laid-Open Publication No. 2004-131530 discloses a method of producing a solid electrolyte membrane by dissolving a compound consisting essentially of polybenzimidazole having the anionic groups into an alcohol solvent containing tetraalkylammonium hydroxide and having a boiling point of not less than 90° C.

A melt-extrusion method and the solution casting method are well known methods of forming a membrane from a polymer. According to the melt-extrusion method, the membrane can be formed without using a solvent. However, this method has problems in that the polymer may denature by heating, impurities in the polymer remain in the produced membrane, and the like. On the other hand, the solution casting method has a problem in that its producing apparatuses become large and complicated since the method requires a producing apparatus of a solution, a solvent recovery device and the like. However, this method is advantageous since a heating temperature of the membrane can be relatively low and it is possible to remove the impurities in the polymer while producing the solution. The solution casting method has a further advantage in that the produced membrane has better planarity and smoothness than the membrane produced by the melt-extrusion method.

Japanese Patent Laid-Open Publication No. 2005-232240 discloses a method of producing a solid electrolyte membrane by the solution casting method. In this method, a solution containing a polymer having an acid group and a solvent is cast on a support to form a casting membrane. The casting membrane is dried at temperatures of a predetermined value or lower and peeled from the support. The peeled membrane is dried again by heating. In this way, the solid electrolyte membrane is produced.

However, in the above-noted Publication No. 9-320617, the solution casting method is denied, and there remains a problem in that the impurities contained in raw materials remain in the produced membrane. The methods disclosed in the above-noted Publication Nos. 2001-307752, 2002-231270, 2004-079378 and 2004-131530 are on a limited scale and not intended to be applied in mass production. The method disclosed in the above-noted Publication No. 2001-307752 has a problem in that it is difficult to disperse a complex consisted of the polymer and the inorganic compound. The method disclosed in the above-noted Publication No. 2002-231270 has a problem in that its membrane producing step is complicated. The method disclosed in the above-noted Publication No. 2004-079378 has a problem in that the produced membrane is not uniform in planarity and smoothness since it has micropores formed during the immersing in the aqueous solution. Any solution for this problem is not cited in the disclosure. Although it is cited in the disclosure that various solid electrolyte membranes can be produced by the solution casting method, any specific method therefor is not cited. The method disclosed in the above-noted Publication No. 2004-131530 limits raw materials to be used and does not mention the usage of other materials having excellent properties.

According to the method disclosed in the above-noted Publication No. 2005-232240, it takes time to dry the casting membrane. In order to produce the membrane continuously, it is necessary to either (1) use a support having long length or (2) regulate running speed of the support slow. Option (1) makes the apparatus large in size, and option (2) lacks production efficiency. Therefore, this method is not preferable for the continuous membrane production.

It is an object of the present invention to provide a solid electrolyte membrane that has uniform quality and excellent ionic conductivity continuously formed from a solid electrolyte, a method and an apparatus of producing the solid electrolyte membrane, and a membrane electrode assembly and a fuel cell using the solid electrolyte membrane.

### DISCLOSURE OF INVENTION

In order to achieve the above and other objects, a method of producing a solid electrolyte membrane of the present invention includes the steps of casting a dope containing a solid electrolyte and an organic solvent from a casting die onto a running support so as to form a casting membrane, and peeling the casting membrane from the support as a wet membrane containing the organic solvent. The method further includes the steps of performing a first drying of the wet membrane in a state that both side edges thereof are held by holding devices, and performing a second drying of the wet membrane supported by rollers to form the solid electrolyte membrane. The second drying step is performed after the first drying step.

It is preferable that a concentration of the solid electrolyte in the dope is 5 wt. % or more and 50 wt. % or less. It is preferable that at least one of the first drying step and the second drying step of the wet membrane is performed by sending air to the vicinity of the wet membrane. It is preferable that the casting membrane is dried by sending air to the vicinity of the casting membrane.

It is preferable that the organic solvent is a mixture of a poor solvent and a good solvent of the solid electrolyte. It is preferable that a weight ratio of the poor solvent in the organic solvent is 10% or more and less than 100%. It is preferable that the good solvent contains dimethylsulfoxide, whereas the poor solvent contains alcohol having 1 to 5 carbons.

It is preferable that the solid electrolyte is a hydrocarbon polymer. It is more preferable that the hydrocarbon polymer is an aromatic polymer having a sulfonic acid group. It is further preferable that the aromatic polymer is a copolymer composed from each structure unit represented as formulae (I), (II) and (III) of a chemical formula 1:

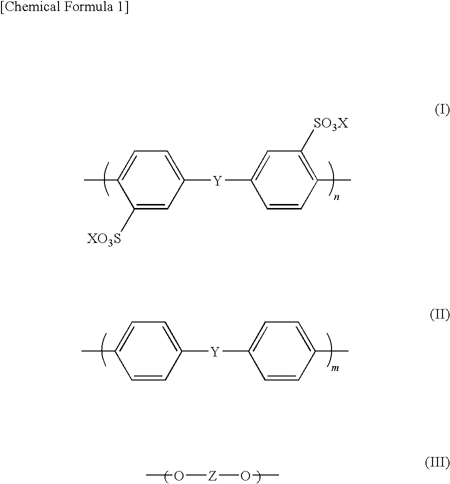

wherein, X is H, Y is SO₂ and Z has a structure shown as a formula (I) or (II) of a chemical formula 2, and n and m satisfy the following condition: 0.1≦n/(m+n)≦0.5.

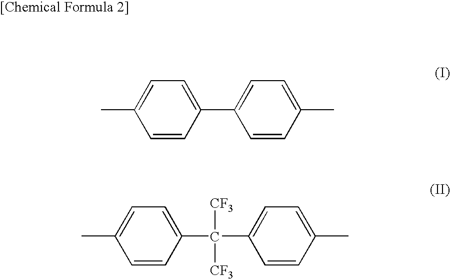

The solid electrolyte membrane of the present invention is produced according to the above-mentioned method.

An apparatus of producing a solid electrolyte membrane of the present invention includes a casting device, a first drying device and a second drying device. The casting device casts a dope containing a solid electrolyte and an organic solvent from a casting die onto a running support so as to form a casting membrane, and peels the casting membrane as a wet membrane containing the organic solvent. The first drying device dries the wet membrane in a state that both side edges thereof are held by holding devices. The second drying device dries the wet membrane supported by rollers to form the solid electrolyte membrane. The second drying device is disposed downstream from the first drying device.

A membrane electrode assembly of the present invention includes the above-mentioned solid electrolyte membrane, an anode and a cathode. The anode is adhered to one surface of the solid electrolyte membrane, and generates protons from a hydrogen-containing material supplied from outside. The cathode is adhered to the other surface of the solid electrolyte membrane, and synthesizes water from the protons permeated through the solid electrolyte membrane and gas supplied from outside.

A fuel cell of the present invention includes the above-mentioned membrane electrode assembly and current collectors. One of the current collectors is provided in contact with the anode, and the other current collector is provided in contact with the cathode. The current collector on the anode side receives and passes electrons between the anode and outside, whereas the current collector on the cathode side receives and passes the electrons between the cathode and outside.

According to the present invention, it is possible to continuously produce the solid electrolyte membrane having uniform quality and excellent ionic conductivity. Moreover, when the membrane electrode assembly using this solid electrolyte membrane is used for the fuel cell, the fuel cell realizes an excellent electromotive force.

### BRIEF DESCRIPTION OF DRAWINGS

FIG. 1 is a schematic diagram illustrating a dope producing apparatus;

FIG. 2 is a schematic diagram illustrating a membrane producing apparatus;

FIG. 3 is a sectional view illustrating a structure of a membrane electrode assembly that uses a solid electrolyte membrane of the present invention; and

FIG. 4 is an exploded sectional view illustrating a structure of a fuel cell that uses the membrane electrode assembly.

### BEST MODE FOR CARRYING OUT THE INVENTION

Embodiments of the present invention are described below in detail. The present invention, however, is not limited to the following embodiments. A solid electrolyte membrane of the present invention is first explained and followed by a producing method thereof.

[Material]

In the present invention, a polymer having a proton donating-group is used as a solid electrolyte, which is formed into a membrane by a producing method described later. The polymer having the proton donating-group is not particularly limited, but may be well-known proton conducting materials having an acid residue. For example, polymer compounds formed by addition polymerization having a sulfonic acid group in side chains, poly(meth)acrylate having a phosphoric acid group in side chains, sulfonated polyether etherketon, sulfonated polybenzimidazole, sulfonated polysulfone, sulfonated heat-resistant aromatic polymer compounds and the like are preferably used. As the polymer compounds formed by addition polymerization having a sulfonic acid group in side chains, there are perfluorosulfonic acid, as typified by Nafion (registered trademark), sulfonated polystyrene, sulfonated polyacrylonitrile styrene, sulfonated polyacrylonitrile butadiene-styrene and the like. As the sulfonated heat-resistant aromatic polymer compounds, there are sulfonated polyimide and the like.

Substances described in, for example, Japanese Patent Laid-Open Publication Nos. 4-366137, 6-231779 and 6-342665 are the preferable examples of the perfluorosulfonic acid, and the substance represented by the following chemical formula 3 is especially preferable above all. However, in the chemical formula 3, m is in the range of 100 to 10000, preferably in the range of 200 to 5000 and more preferably in the range of 500 to 2000. In addition, n is in the range of 0.5 to 100, and especially preferably in the range of 5 to 13.5. Moreover, x is nearly equal to m, and y is nearly equal to n.

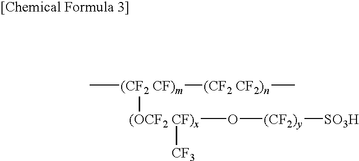

Compounds described in, for example, Japanese Patent Laid-Open Publication Nos. 5-174856 and 6-111834, or the substance represented by the following chemical formula 4 are the preferable examples of the sulfonated polystyrene, the sulfonated polyacrylonitrile styrene and the sulfonated polyacrylonitrile butadiene-styrene.

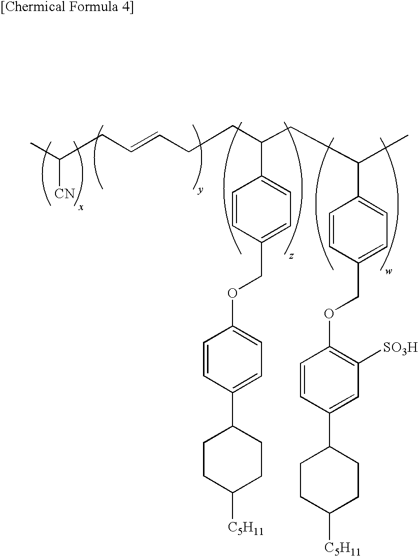

Substances described in, for example, Japanese Patent Laid-Open Publication Nos. 6-49302, 2004-10677, 2004-345997, 2005-15541, 2002-110174, 2003-100317, 2003-55457, 9-245818, 2003-257451 and 2002-105200, and International Publication No. WO97/42253 (corresponding to National Publication of Translated Version No. 2000-510511) are the examples of the sulfonated heat-resistant aromatic polymer compounds, and the substances represented by the above-noted chemical formula 1 and the following chemical formulae 5 and 6 are especially preferable above all.

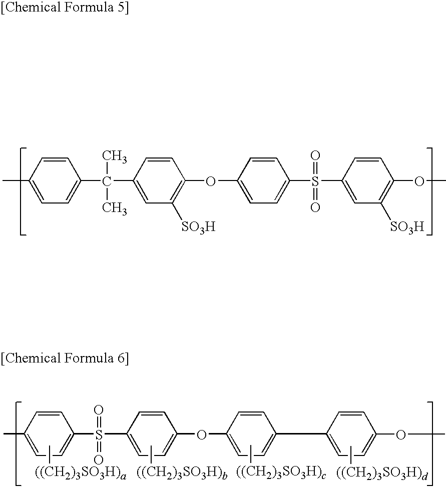

Especially, a membrane made from the substance represented by the chemical formula 1 achieves a good balance between hygroscopic expansion coefficient and the proton conductivity. In the case of n/(m+n)<0.1, the number of the sulfonic acid group is too small to form a proton conducting path, which is so called a proton channel. As a result, the produced membrane may not have enough proton conductivity for actual use. In the case of n/(m+n)>0.5, the produced membrane has excessively high water absorption rate, which makes the produced membrane have a high expansion rate due to the absorption. As a result, the produced membrane may be easily deteriorated.

Sulfonation reaction on the process of obtaining the above-mentioned compounds can be performed in accordance with various synthetic methods described in the disclosed publications. Sulfuric acid (concentrated sulfuric acid), fuming sulfuric acid, gaseous or liquid sulfur trioxide, sulfur trioxide complex, amidosulfuric acid, chlorosulfonic acid and the like are used as sulfonating agents. Hydrocarbon (benzene, toluene, nitrobenzene, chlorobenzene, dioxetane and the like), alkyl halide (dichloromethane, chloroform, dichloroethane, tetrachloromethane and the like) and the like are used as a solvent. Reaction temperature in the sulfonation reaction is determined within the range of −20° C. to 200° C. in accordance with the sulfonating agent activity. It is also possible to previously introduce a mercapto group, a disulfide group or a sulfinic acid group in a monomer, and synthesize the sulfonated compound by the oxidation reaction with an oxidant. In this case, hydrogen peroxide, nitric acid, bromine water, hypochlorite, hypobromite, potassium permanganate, chromic acid and the like are used as the oxidant. Water, acetic acid, propionic acid and the like are used as the solvent. The reaction temperature according to this method is determined within the range of a room temperature (for example, 25° C.) to 200° C. in accordance with the oxidant activity. It is also possible to previously introduce a halogeno-alkyl group in the monomer, and synthesize the sulfonated compound by the substitution reaction of sulfite, hydrogen sulfite and the like. In this case, water, alcohol, amide, sulfoxide, sulfone and the like are used as the solvent. The reaction temperature according to this method is determined within the range of the room temperature (for example, 25° C.) to 200° C. The solvent used for the above-mentioned sulfonation reactions can be a mixture of two or more substances.

In the reaction process to synthesize the sulfonated compound, an alkyl sulfonating agent can be used, and Friedel-Crafts reaction (Journal of Applied Polymer Science, Vol. 36, 1753-1767, 1988) using sulfone and AlCl₃ is a common method. When using the alkyl sulfonating agent for the Friedel-Crafts reaction, hydrocarbon (benzene, toluene, nitrobenzene, acetophenon, chlorobenzene, trichlorobenzene and the like), alkyl halide (dichloromethane, chloroform, dichloroethane, tetrachloromethane, trichloroethane, tetrachloroethane and the like) and the like are used as the solvent. The reaction temperature is determined in the range of the room temperature to 200° C. The solvent used for the above-mentioned Friedel-Crafts reaction can be a mixture of two or more substances.

In order to produce the solid electrolyte membrane having the structure represented by the chemical formula 1, a dope containing a polymer (hereinafter, precursor) in which X in the chemical formula 1 is cationic species other than hydrogen atom (H) is first produced. The dope is cast on a support and is peeled as a membrane containing the precursor (hereinafter, precursor membrane). The precursor membrane is protonated to substitute H for the cationic species X, thereby producing the solid electrolyte membrane formed from the polymer having the structure of the chemical formula 1.

The cationic species is an atom or an atom group that generates a cation when ionizing. The cationic species is not necessarily univalent. Besides the proton, alkali metal cation, alkali earth metal cation and ammonium cation are preferable, and calcium ion, barium ion, quaternary ammonium ion, lithium ion, sodium ion and potassium ion are more preferable as the cation. Even if the substitution of H for the cationic species X in the chemical formula 1 is not performed, the produced membrane functions as the solid electrolyte. However, the proton conductivity of the membrane increases as the percentage of the substitution of H for the cationic species X increases. In view of this, X is especially preferably H.

The solid electrolyte preferably has the following properties. An ionic conductivity is preferably not less than 0.005 S/cm, and more preferably not less than 0.01 S/cm at a temperature of 25° C. and at a relative humidity of 70%, for example. Moreover, after the solid electrolyte membrane has been soaked in a 50% methanol aqueous solution for a day at the temperature of 18° C., the ionic conductivity is not less than 0.003 S/cm, and more preferably not less than 0.008 S/cm. At this time, it is particularly preferable that a percentage of reduction in the ionic conductivity of the solid electrolyte as compared to that before the soaking is not more than 20%. Furthermore, a methanol diffusion coefficient is preferably not more than 4×10⁻⁷ cm²/sec, and especially preferably not more than 2×10⁻⁷ cm²/sec.

As to strength, the solid electrolyte membrane preferably has elastic modulus of not less than 10 MPa, and especially preferably of not less than 20 MPa. Note that the measuring method of the elastic modulus is described in detail in paragraph [0138] of Japanese Patent Laid-Open Publication No. 2005-104148. The above-noted values of the elastic modulus are obtained by a tensile tester (manufactured by Toyo Baldwin Co., Ltd.). In order to obtain the elastic modulus of the solid electrolyte membrane by other testing methods or testers, it is preferable to previously correlate the value thereof with that of the above-noted testing method and the tester.

As to durability, after a test with time in which the solid electrolyte membrane has been soaked into the 50% methanol aqueous solution at a constant temperature, a percentage of change in each of weight, ion exchange capacity and the methanol diffusion coefficient as compared to that before the soaking is preferably not more than 20%, and especially preferably not more than 15%. Moreover, in a test with time in hydrogen peroxide, the percentage of change in each of the weight, the ion exchange capacity and the methanol diffusion coefficient as compared to that before the soaking is preferably not more than 20%, and especially preferably not more than 10%. Furthermore, coefficient of volume expansion of the solid electrolyte membrane in the 50% methanol aqueous solution at a constant temperature is preferably not more than 10%, and especially preferably not more than 5%.

In addition, it is preferable that the solid electrolyte has stable ratios of water absorption and water content. It is also preferable that the solid electrolyte has extremely low solubility in alcohol, water, or a mixture of alcohol and water to the extent that it is practically negligible. It is also preferable that weight reduction and shape change of the solid electrolyte membrane after it has been soaked in the above-mentioned liquid are small enough to be practically negligible.

The ionic conductivity property of the solid electrolyte membrane is represented by so-called index, which is a ratio of the ionic conductivity to methanol transmission coefficient. When the index is high in a particular direction, the ionic conductivity property in that direction is high. In thickness direction of the solid electrolyte membrane, the ionic conductivity is proportional to the thickness, while the methanol transmission coefficient is inversely proportional to the thickness. Therefore, the property of the ionic conductivity in the solid electrolyte membrane is controlled by changing the thickness thereof. The solid electrolyte membrane used for a fuel cell is provided with an anode on one surface and a cathode on the other surface thereof. Accordingly, it is preferable that the index is higher in the thickness direction of the membrane than that in other directions thereof. The thickness of the solid electrolyte membrane is preferably in the range of 10 μm to 30 μm. When, for example, the ionic conductivity and the methanol diffusion coefficient are both high in the solid electrolyte, it is especially preferable to produce the membrane with a thickness of 50 μm to 200 μm. When, for example, the ionic conductivity and the methanol diffusion coefficient are both low in the solid electrolyte, it is especially preferable to produce the membrane with the thickness of 20 μm to 100 μm.

Allowable temperature limit is preferably not less than 200° C., more preferably not less than 250° C., and especially preferably not less than 300° C. The allowable temperature limit here means the temperature at which reduction in weight of the solid electrolyte membrane reaches 5% as it is heated at a rate of 1° C./min. Note that the weight reduction is calculated with the exception of evaporated contents of water and the like.

When the solid electrolyte is formed in the membrane form and used for the fuel cell, the maximum power (output) density thereof is preferably not less than 10 mW/cm².

By use of the above-described solid electrolyte, it is possible to produce a solution dope preferable for the membrane production, and at the same time, it is possible to produce the solid electrolyte membrane preferable for the fuel cell. The solution preferable for the membrane production is, for example, a solution whose viscosity is relatively low, and from which foreign matters are easily removed through filtration. Note that the obtained solution is hereinafter referred to as the dope.

Any organic compound capable of dissolving the polymer as the solid electrolyte can be the solvent of the dope. For example, there are aromatic hydrocarbon (for example, benzene, toluene and the like), halogenated hydrocarbon (for example, dichloromethane, chlorobenzene and the like), alcohol (for example, methanol, ethanol, n-propanol, n-butanol, diethylene glycol and the like), ketone (for example, acetone, methylethyl ketone and the like), ester (for example, methylacetate, ethylacetate, propylacetate and the like), ether (for example, tetrahydrofuran, methyl cellosolve and the like), nitrogen compound (N-methylpyrrolidone (NMP), N,N-dimethylformamide (DMF), N,N′-dimethylacetamide (DMAc) and the like), dimethylsulfoxide (DMSO) and so forth.

The solvent of the dope may be a mixture of a plurality of the substances. When the solvent is the mixture, it is preferable to use a good solvent and a poor solvent of the solid electrolyte as the substances. When protonation is performed during the step of producing the solid electrolyte membrane having the structure represented by the chemical formula 1, it is preferable to use the mixture of the good solvent and the poor solvent of the precursor as the solvent. Whether the used substance is the good solvent or the poor solvent of the solid electrolyte can be distinguished by checking the presence of insoluble residues in a mixture of the solvent and the solid electrolyte. At this time, the solid electrolyte is mixed to have the weight of 5 wt. % of the total weight. The good solvent of the solid electrolyte in which the solid electrolyte is dissolved has a relatively high boiling point among the compounds commonly used as a solvent. On the other hand, the poor solvent of the solid electrolyte has a relatively low boiling point among the same. By mixing the poor solvent to the good solvent, the boiling point of the mixture in which the solid electrolyte is dissolved is lowered. Accordingly, it is possible to enhance efficiency and effectiveness of the solvent removal in the membrane producing step by mixing the poor and good solvents. This especially improves the efficiency in drying of the casting membrane.

In the mixture of the good and poor solvents, it is preferable that the poor solvent has as high weight percentage as possible. Particularly, it is preferable that the weight percentage of the poor solvent is not less than 10% and less than 100%. It is more preferable that (weight of the good solvent):(weight of the poor solvent) is 90:10 to 10:90. Owing to the high weight percentage of the poor solvent, the weight percentage of the low-boiling point component in the whole solvent becomes high, thereby further enhancing the drying efficiency and effectiveness in the membrane producing step of the solid electrolyte membrane.

As the good solvent components, DMF, DMAc, DMSO and NMP are preferable. Among these, the DMSO is most preferable from a safety standpoint and in view of its relatively low boiling point. As the poor solvent components, lower alcohol that has 1 or more and 5 or less carbons, methylacetate and acetone are preferable. Among these, the lower alcohol having 1 or more and 3 or less carbons is more preferable. When the DMSO is used as the good solvent component, methyl alcohol is especially preferable as the poor solvent component since it has best solubility in the DMSO.

In order to improve the various properties of the solid electrolyte membrane, it is possible to add additives to the dope. As the additives, there are antioxidants, fibers, fine particles, water absorbing agents, plasticizers and compatibilizing agents and the like. It is preferable that a concentration of these additives is in the range of not less than 1 wt. % and 30 wt. % or less when the entire solid contents of the dope is 100 wt. %. Note, however, that the concentration and the sorts of the additives have to be determined not to adversely affect on the ionic conductivity. Hereinafter, the additives are explained in detail.

As the antioxidants, (hindered) phenol-type compounds, monovalent or divalent sulfur-type compounds, trivalent phosphorus-type compounds, benzophenone-type compounds, benzotriazole-type compounds, hindered amine-type compounds, cyanoacrylate-type compounds, salicylate-type compounds, oxalic acid anilide-type compounds are the preferable examples. The compounds described in Japanese Patent Laid-Open Publication Nos. 8-053614, 10-101873, 11-114430 and 2003-151346 are the specific examples thereof.

As the fibers, perfluorocarbon fibers, cellulose fibers, glass fibers, polyethylene fibers and the like are the preferable examples. The fibers described in Japanese Patent Laid-Open Publication Nos. 10-312815, 2000-231938, 2001-307545, 2003-317748, 2004-063430 and 2004-107461 are the specific examples thereof.

As the fine particles, titanium oxide, zirconium oxide and the like are the preferable examples. The fine particles described in Japanese Patent Laid-Open Publication Nos. 2003-178777 and 2004-217931 are the specific examples thereof.

As the water absorbing agents, that is, the hydrophilic materials, cross-linked polyacrylate salt, starch-acrylate salt, poval (polyvinyl alcohol), polyacrylonitrile, carboxymethyl cellulose, polyvinyl pyrrolidone, polyglycol dialkyl ether, polyglycol dialkyl ester, synthetic zeolite, titania gel, zirconia gel and yttria gel are the preferable examples. The water absorbing agents described in Japanese Patent Laid-Open Publication Nos. 7-135003, 8-020716 and 9-251857 are the specific examples thereof.

As the plasticizers, phosphoric acid ester-type compound, chlorinated paraffin, alkyl naphthalene-type compound, sulfone alkylamide-type compound, oligoether group, aromatic nitrile group are the preferable examples. The plasticizers described in Japanese Patent Laid-Open Publication Nos. 2003-288916 and 2003-317539 are the specific examples thereof.

As the compatibilizing agents, those having a boiling point or a sublimation point of not less than 250° C. are preferable, and those having the same of not less than 300° C. are more preferable.

The dope may contain various kinds of polymer compounds for the purpose of (1) enhancing the mechanical strength of the membrane, and (2) improving the acid concentration in the membrane.

For the purpose of (1), a polymer having a molecular weight in the range of 10000 to 1000000 or so and well compatible with (soluble to) the solid electrolyte is preferably used. For example, the polymer such as perfluorinated polymer, polystyrene, polyethylene glycol, polyoxetane, polyether ketone, polyether sulfone, and the polymer compound having the repeating unit of at least two of these polymers are preferable. Preferably, the polymer content of the membrane is in the range of 1 wt. % to 30 wt. % of the total weight. It is also possible to use the compatibilizing agent in order to enhance the compatibility of the polymer with the solid electrolyte. As the compatibilizing agent, those having the boiling point or the sublimation point of not less than 250° C. are preferable, and those having the same of not less than 300° C. are more preferable.

For the purpose of (2), proton acid segment-having polymer and the like are preferably used. Perfluorosulfonic acid polymers such as Nafion (registered trademark), sulfonated polyether etherketon having a phosphoric acid group in side chains, and the sulfonated heat-resistant aromatic polymers such as sulfonated polyether sulfone, sulfonated polysulfone, sulfonated polybenzimidazole and the like are the preferable examples thereof. Preferably, the polymer content of the membrane is in the range of 1 wt. % to 30 wt. % of the total weight.

When the obtained solid electrolyte membrane is used for the fuel cell, an active metal catalyst that promotes the redox reaction of anode fuel and cathode fuel may be added to the dope. By adding the active metal catalyst, the fuel having penetrated into the solid electrolyte from one electrode is well consumed inside the solid electrolyte and does not reach the other electrode, and therefore this is effective for preventing a crossover phenomenon. The active metal catalyst is not particularly limited as long as it functions as an electrode catalyst, but platinum or platinum-based alloy is especially preferable.

[Dope Production]

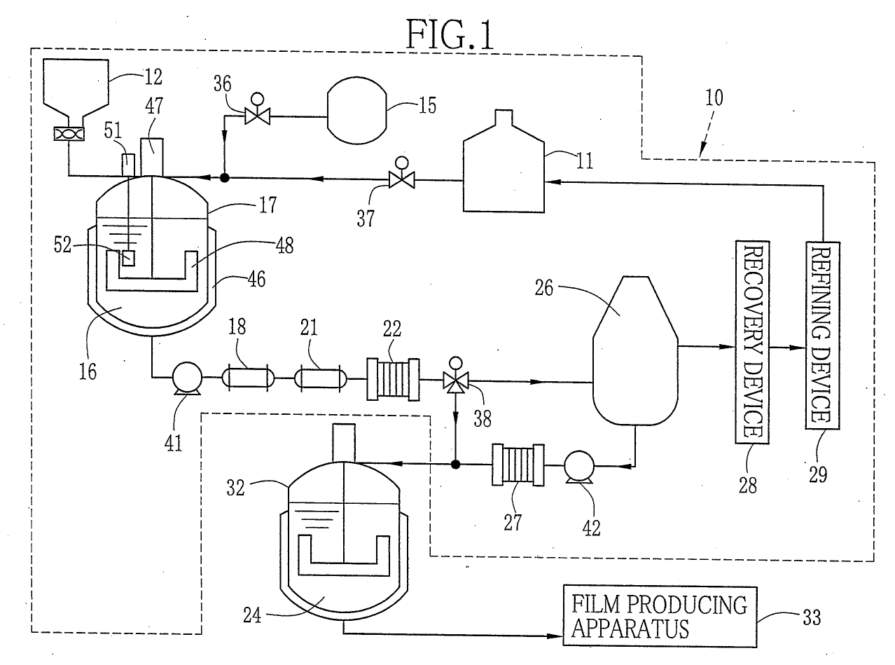

In FIG. 1, a dope producing apparatus is shown. Note, however, that the present invention is not limited to the dope producing apparatus shown in FIG. 1. A dope producing apparatus 10 is provided with a solvent tank 11 for storing the solvent, a hopper 12 for supplying the solid electrolyte, an additive tank 15 for storing the additive, a mixing tank 17 for mixing the solvent, the solid electrolyte and the additive so as to make a mixture 16, a heater 18 for heating the mixture 16, a temperature controller 21 for controlling a temperature of the heated mixture 16, a filtration device 22 for filtering the mixture 16 fed out of the temperature controller 21, a flash device 26 for controlling a concentration of a dope 24 from the filtration device 22, and a filtration device 27 for filtering the concentration-controlled dope 24. The dope producing apparatus 10 is further provided with a recovery device 28 for recovering the solvent, and a refining device 29 for refining the recovered solvent. The dope producing apparatus 10 is connected to a membrane producing apparatus 33 through a stock tank 32. Note that the dope producing apparatus is also provided with valves 36, 37 and 38 for controlling amount of feeding, and feeding pumps 41 and 42. The number and the position of the valves and feeding pumps are changed as appropriate.

First of all, the valve 37 is opened to feed the solvent from the solvent tank 11 to the mixing tank 17. Successively, the solid electrolyte stored in the hopper 12 is sent to the mixing tank 17. At this time, the solid electrolyte may be continuously sent by a feeding device that performs measuring and sending continuously, or may be intermittently sent by a feeding device that measures a predetermined amount of the solid electrolyte first and sends the solid electrolyte of that amount. In addition, an additive solution is sent by a necessary amount from the additive tank 15 to the mixing tank 17 by adjusting the degree of opening of the valve 36.

In the case where the additive is liquid at room temperature, it is possible to send the additive in a liquid state to the mixing tank 17 instead of sending it as solution. Meanwhile, in the case where the additive is solid, it is possible to send the additive to the mixing tank 17 by using the hopper and so forth. When plural kinds of additives are added, the additive tank 15 may contain a solution in which the plural kinds of the additives are dissolved. Alternatively, many additive tanks may be used for respectively containing a solution in which one kind of the additive is dissolved. In this case, the additive solutions are respectively sent to the mixing tank 17 through an independent pipe.

In the above description, the solvent, the solid electrolyte and the additive are sent to the mixing tank 17 in this order. However, this order is not exclusive. For example, the solvent of an appropriate amount may be sent after the solid electrolyte has been sent to the mixing tank 17. By the way, the additive is not necessarily contained in the mixing tank 17 beforehand. The additive may be mixed in a mixture of the solid electrolyte and the solvent during a succeeding process by an in-line mixing method and so forth.

It is preferable that the mixing tank 17 is provided with a jacket for covering an outer surface thereof, a first stirrer 48 rotated by a motor 47, and a second stirrer 52 rotated by a motor 51. A temperature of the mixing tank 17 is regulated by a heat transfer medium flowing inside the jacket. A preferable temperature range of the mixing tank 17 is −10° C. to 55° C. The first stirrer 48 and the second stirrer 52 are properly selected and used to swell the solid electrolyte in the solvent so that the mixture 16 is obtained. Preferably, the first stirrer 48 has an anchor blade and the second stirrer 52 is a decentering stirrer of dissolver type.

Next, the mixture 16 is sent to the heater 18 by the pump 41. It is preferable that the heater 18 is piping with a jacket (not shown) for letting a heat transfer medium flow between the piping and the jacket. It is further preferable that the heater 18 has a pressure portion (not shown) for pressurizing the mixture 16. By using this kind of the heater 18, solid contents of the mixture 16 are effectively and efficiently dissolved into the solvent under a heating condition or a pressurizing/heating condition. Hereinafter, the method of dissolving the solid contents into the solvent by heating is referred to as a heat-dissolving method. In this case, it is preferable that the mixture 16 is heated to have the temperature of 60° C. to 250° C.

Instead of the heat-dissolving method, it is possible to perform a cool-dissolving method in order to dissolve the solid contents into the solvent. The cool-dissolving method is a method to promote the dissolution while maintaining the temperature of the mixture 16 or cooling the mixture 16 to have lower temperatures. In the cool-dissolving method, it is preferable that the mixture 16 is cooled to −100° C. to −10° C. The above-mentioned heat-dissolving method and the cool-dissolving method make it possible to sufficiently dissolve the solid electrolyte in the solvent.

After the mixture 16 has reached about a room temperature by means of the temperature controller 21, the mixture 16 is filtered by the filtration device 22 to remove foreign matter like impurities or aggregations contained therein. The filtered mixture 16 is the dope 24. It is preferable that a filter used for the filtration device 22 has an average pore diameter of 50 μm or less.

The dope 24 after the filtration is sent to and pooled in the stock tank 32, and used for producing the membrane.

By the way, the method of swelling the solid contents once and dissolving it to produce the solution as described above takes a longer time as a concentration of the solid electrolyte in the solution increases, and it causes a problem concerning production efficiency. In view of this, it is preferable that the dope is prepared to have a lower concentration relative to an intended concentration, and a concentration process is performed to obtain the intended concentration after preparing the dope. For example, the dope 24 filtered by the filtration device 22 is sent to the flash device 26 by the valve 38, and the solvent of the dope 24 is partially evaporated in the flash device 26 to be concentrated. The concentrated dope 24 is extracted from the flash device 26 by the pump 42 and sent to the filtration device 27. At the time of filtration by the filtration device 27, it is preferable that a temperature of the dope 24 is 0° C. to 200° C. After removing foreign matter by the filtration device 27, the dope 24 is sent to and pooled in the stock tank 32, and used for producing the membrane. Note that the concentrated dope 24 may contain bubbles. It is therefore preferable that a defoaming process is performed before sending the dope 24 to the filtration device 27. As the method for removing the bubbles, various well-known methods are applicable. For example, there is an ultrasonic irradiation method in which the dope 24 is irradiated with an ultrasonic.

Solvent vapor generated due to the evaporation in the flash device 26 is condensed by the recovery device 28 having a condenser (not shown) and becomes a liquid to be recovered. The recovered solvent is refined by the refining device 29 as the solvent to be reused for preparing the dope. Such recovering and reusing are advantageous in terms of production cost, and also prevent adverse effects on human bodies and the environment in a closed system.

By the above method, the dope 24 having the solid electrolyte concentration or the precursor concentration of 5 wt. % or more and 50 wt. % or less is produced. It is more preferable that the solid electrolyte concentration or the precursor concentration is 10 wt. % or more and 40 wt. % or less. Meanwhile, as to a concentration of the additive, it is preferable that a range thereof is 1 wt. % or more and 30 wt. % or less when the entire solid contents of the dope is defined as 100 wt. %.

[Membrane Production]

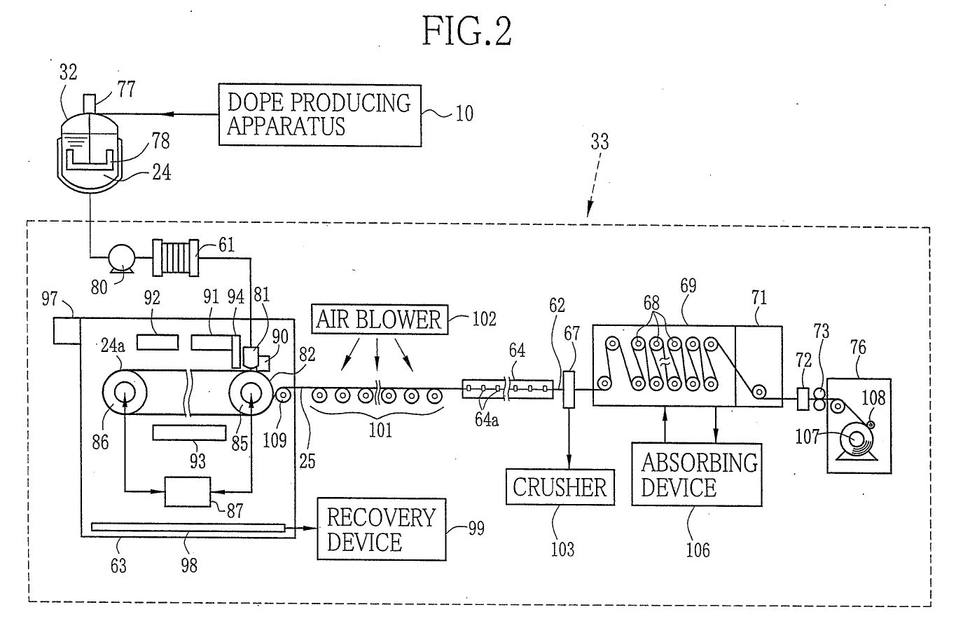

Hereinafter, a method of producing the solid electrolyte membrane is explained. In FIG. 2, the membrane producing apparatus 33 is shown. Note, however, that the present invention is not limited to the membrane producing apparatus shown in FIG. 2. The membrane producing apparatus 33 is provided with a filtration device 61 for removing foreign matter contained in the dope 24 sent from the stock tank 32, a casting chamber 63 for casting the dope 24 filtered by the filtration device 61 to form a wet membrane 25, a tenter drier 64 for drying the wet membrane 25 while transporting it in a state that both side edges thereof are held by clips, an edge slitting device 67 for cutting off both side edges of a solid electrolyte membrane (hereinafter, merely referred to as the membrane) 62, a drying chamber 69 for drying the membrane 62 while transporting it in a state that the membrane 62 is bridges across plural rollers 68, a cooling chamber 71 for cooling the membrane 62, a neutralization device 72 for reducing a charged voltage of the membrane 62, a knurling roller pair 73 for performing emboss processing on both side edges of the membrane 62, and a winding chamber 76 for winding up the membrane 62.

The stock tank 32 is provided with a stirrer 78 rotated by a motor 77. By the rotation of the stirrer 78, deposition or aggregation of the solid contents in the dope 24 is inhibited. The stock tank 32 is connected to the filtration device 61 through a pump 80. It is preferable that a filter used for the filtration device 61 has an average pore diameter of 10 μm or less. With this configuration, impurities which may cause deterioration in primary performance of the proton conductivity and time degradation of the proton conductivity are prevented from mixed into the membrane 62. The presence or absence of the impurities like insoluble substances can be evaluated by observing the dope 24 taken as a sample from the stock tank 32 under fluorescent lights.

A casting die 81 for casting the dope 24, and a belt 82 as a running support are provided in the casting chamber 63. As a material of the casting die 81, precipitation hardened stainless steel is preferable and it is preferable that a coefficient of thermal expansion thereof is 2×10⁻⁵ (° C.⁻¹) or less. It is preferable that the material has anti-corrosion properties, which is substantially equivalent with SUS316 on a compulsory corrosion examination performed in an electrolyte aqueous solution. Further, it is preferable that the material has anti-corrosion properties in which pitting is not caused at a gas-liquid interface after soaked in a mixed liquid of dichloromethane, methanol and water for three months. Moreover, it is preferable to make the casting die 81 by grinding a material after at least one month has passed from foundry. In virtue of this, the dope 24 uniformly flows inside the casting die 81 and it is prevented that streaks are caused on a casting membrane 24a described later. As to finishing accuracy of a dope contact surface of the casting die 81, it is preferable that surface roughness is 1 μm or less and straightness is 1 μm/m or less in any direction. Slit clearance of the casting die 81 is adapted to be automatically adjusted within the range of 0.5 mm to 3.5 mm. With respect to a corner portion of a lip edge of the casting die 81, a chamfered radius R thereof is adapted to be 50 μm or less in the entire width. Furthermore, it is preferable that the casting die 81 is a coat-hanger type die.

A width of the casting die 81 is not especially limited. However, it is preferable that the width thereof is 1.1 to 2.0 times a width of a membrane as a final product. Moreover, it is preferable that a temperature controller is attached to the casting die 81 to maintain a predetermined temperature of the dope 24 during membrane formation. Furthermore, it is preferable that heat bolts for adjusting a thickness are disposed in a width direction of the casting die 81 at predetermined intervals and the casting die 81 is provided with an automatic thickness adjusting mechanism utilizing the heat bolts. In this case, the heat bolt sets a profile and forms a membrane along a preset program in accordance with a liquid amount sent by the pump 80. In order to precisely control the sending amount of the dope 24, the pump 80 is preferably a high-accuracy gear pump. Furthermore, feedback control may be performed over the automatic thickness adjusting mechanism. In this case, a thickness gauge such as an infrared thickness gauge is disposed at the membrane producing apparatus 33, and the feedback control is performed along an adjustment program on the basis of a profile of the thickness gauge and a detecting result from the thickness gauge. It is preferable that the casting die 81 is capable of adjusting the slit clearance of the lip edge to be ±50 μm or less so as to regulate a thickness difference between any two points, which are located within an area excepting an edge portion, of the membrane 62 as the final product to be 1 μm or less.

Preferably, a hardened layer is formed on the lip edge of the casting die 81. A method for forming the hardened layer is not especially limited. There are ceramic coating, hard chrome-plating, nitriding treatment method and so forth. When the ceramic is utilized as the hardened layer, it is preferable that the ceramic has grindable properties, low porosity, strength, excellent resistance to corrosion, and no affinity and no adhesiveness to the dope 24. Concretely, there are tungsten carbide (WC), Al₂O₃, TiN, Cr₂O₃ and so forth. Among these, the WC is especially preferable. It is possible to perform WC coating by a thermal spraying method.

It is preferable that a solvent supplying device (not shown) is attached near the lip edge of the casting die 81 in order to prevent the dope from being partially dried and solidified at the lip edge. It is preferable to supply a solvent to a peripheral portion of three-phase contact lines formed by both end portions of a casting bead, both end portions of the lip edge, and ambient air. It is preferable to supply the solvent to each side of the end portions at a rate of 0.1 mL/min to 1.0 mL/min. Owing to this, foreign matter such as the solid contents separated out from the dope 24, or extraneous matter mixed into the casting bead from outside can be prevented from entering into the casting membrane 24a. As a pump for supplying the solvent, it is preferable to use the one having a pulsation rate of 5% or less.

The belt 82 under the casting die 81 is supported by the rollers 85 and 86. The belt 82 is continuously transported by the rotation of at least one of these rollers 85 and 86.

A width of the belt 82 is not especially limited. However, it is preferable that the width of the belt 82 is 1.1 to 2.0 times the casting width of the dope 24. Preferably, a length of the belt 82 is 20 m to 200 m, and a thickness thereof is 0.5 mm to 2.5 mm. It is preferable that the belt 82 is ground so as to have surface roughness of 0.05 μm or less.

A material of the belt 82 is not especially limited, but preferably stainless. As the material of the belt 82 besides stainless, there are nonwoven plastic films such as polyethylene terephthalate (PET) film, polybutylene terephthalate (PBT) film, nylon 6 film, nylon 6,6 film, polypropylene film, polycarbonate film, polyimide film and the like. It is preferable to use lengthy material having enough chemical stability for the used solvent and enough heat resistance to the membrane forming temperature.

It is preferable that a heat transfer medium circulator 87, which supplies a heat medium to the rollers 85 and 86 so as to control surface temperatures thereof, is attached to the rollers 85 and 86. For this configuration, a surface temperature of the belt 82 is kept at a predetermined value. In this embodiment, a passage (not shown) for the heat transfer medium is formed in the respective rollers 85 and 86. The heat transfer medium maintained at a predetermined temperature passes through the inside of the passage to keep a temperature of the respective rollers 85 and 86 at a predetermined value. The surface temperature of the belt 82 is appropriately set in accordance with a kind of the solvent, a kind of the solid contents, a concentration of the dope 24 and the like.

Instead of the rollers 85 and 86, and the belt 82, it is also possible to use a casting drum (not shown) as the support. In this case, it is preferable that the casting drum is capable of accurately rotating with rotational speed unevenness of 0.2% or less. Moreover, it is preferable that the casting drum has average surface roughness of 0.01 μm or less. The surface of the casting drum is hard chrome plated so as to have sufficient hardness and durability. Furthermore, it is preferable to minimize surface defect of the casting drum, belt 82, and rollers 85 and 86. Concretely, it is preferable that there is no pinhole of 30 μm or more, and a number of the pinholes of 10 μm or more and less than 30 μm is at most one per square meter, and a number of the pinholes of less than 10 μm is at most two per square meter.

It is preferable to dispose a decompression chamber 90 for controlling a pressure of the casting bead, which is formed between the casting die 81 and the belt 82, at its upstream side in the running direction of the belt 82.

Air blowers 91, 92 and 93 that blow air for vaporizing the solvent of the casting membrane 24a, and an air shielding plate 94 that prevents the air causing ununiformity in a shape of the casting membrane 24a from blowing onto the casting membrane 24a are provided near the casting die 81.

The casting chamber 63 is provided with a temperature regulator 97 for maintaining an inside temperature thereof at a predetermined value, and a condenser 98 for condensing and recovering solvent vapor. A recovery device 99 for recovering the condensed and devolatilized organic solvent is disposed at the outside of the casting chamber 63.

A transfer section 101 that is disposed downstream from the casting chamber 63 is provided with an air blower 102. The edge slitting device 67 is provided with a crusher 103 for shredding side edges cut from the membrane 62.

The drying chamber 69 is provided with an absorbing device 106 to absorb and recover solvent vapor generated due to evaporation. In FIG. 2, the cooling chamber 71 is disposed downstream from the drying chamber 69. However, a humidity-controlling chamber (not shown) for controlling water content of the membrane 62 may be disposed between the drying chamber 69 and the cooling chamber 71. The neutralization device 72 is a forced neutralization device like a neutralization bar and the like, and capable of adjusting the charged voltage of the membrane 62 within a predetermined range (for example, −3 kV to +3 kV). Although the neutralization device 72 is disposed at the downstream side from the cooling device 71 in FIG. 2, this setting position is not exclusive. The knurling roller pair 73 forms knurling on both side edges of the membrane 62 by emboss processing. The inside of the winding chamber 76 is provided with a winding roller 107 for winding the membrane 62, and a press roller 108 for controlling tension at the time of winding.

Next, an embodiment of a method for producing the membrane 62 by using the above-described membrane producing apparatus 33 is described. The dope 24 is always uniformed by the rotation of the stirrer 78. Various additives may be mixed in the dope 24 during the stir.

The dope 24 is sent to the stock tank 32 by the pump 80, and deposition or aggregation of the solid contents in the dope 24 is inhibited by the stir. After that, the dope 24 is filtered by the filtration device 61 so as to remove the foreign matter having a size larger than a predetermined radius or foreign matter in a gel form.

The dope 24 is then cast from the casting die 81 onto the belt 82. In order to regulate the tension of the belt 82 to 10³ N/m to 106 N/m, a relative position of the rollers 85 and 86, and a rotation speed of at least one of the rollers 85 and 86 are adjusted. Moreover, a relative speed difference between the belt 82 and the rollers 85 and 86 are adjusted so as to be 0.01 m/min or less. Preferably, speed fluctuation of the belt 82 is 0.5% or less, and meandering thereof caused in a width direction is 1.5 mm or less while the belt 82 makes one rotation. In order to control the meandering, it is preferable to provide a detector (not shown) for detecting the positions of both sides of the belt 82 and a position controller (not shown) for adjusting the position of the belt 82 according to detection data of the detector, and performs feed back control of the position of the belt 82. With respect to a portion of the belt 82 located just under the casting die 81, it is preferable that vertical positional fluctuation caused in association with the rotation of the roller 85 is adjusted so as to be 200 μm or less. Further, it is preferable that the temperature of the casting chamber 63 is adjusted within the range of −10° C. to 57° C. by the temperature regulator 97. Note that the solvent vaporized inside the casting chamber 63 is reused as dope preparing solvent after being collected by the recovery device 99.

The casting bead is formed between the casting die 81 and the belt 82, and the casting membrane 24a is formed on the belt 82. In order to stabilize a form of the casting bead, it is preferable that an upstream-side area from the bead is controlled by the decompression chamber 90 so as to be set to a desired pressure value. Preferably, the upstream-side area from the bead is decompressed within the range of −2500 Pa to −10 Pa relative to its downstream-side area from the casting bead. Incidentally, it is preferable that a jacket (not shown) is attached to the decompression chamber 90 to maintain the inside temperature at a predetermined temperature. Additionally, it is preferable to attach a suction unit (not shown) to an edge portion of the casting die 81 and suctions both sides of the bead in order to keep a desired shape of the casting bead. A preferable range of an air amount for aspirating the edge is 1 L/min to 100 L/min.

After the casting membrane 24a has possessed a self-supporting property, this casting membrane 24a is peeled from the belt 82 as the wet membrane 25 while supported by a peeling roller 109. The peeled wet membrane 25 contains the solvent. After that, the wet membrane 25 is carried along the transfer section 101 provided with many rollers, and then fed into the tenter drier 64. In the transfer section 101, it is possible to give a draw tension to the wet membrane 25 by increasing a rotation speed of the downstream roller in comparison with that of the upstream roller. In the transfer section 101, dry air of a desired temperature is sent near the wet membrane 25, or directly blown to the wet membrane 25 from the air blower 102 to facilitate a drying process of the wet membrane 25. At this time, it is preferable that the temperature of the dry air is 20° C. to 250° C.

The wet membrane 25 fed into the tenter drier 64 is dried while carried in a state that both side edges thereof are held with holding devices such as clips 64a. At this time, pins may be used instead of the clips. The pins may be penetrated through the wet membrane 25 to support it. It is preferable that the inside of the tenter drier 64 is divided into temperature zones and drying conditions are properly adjusted in each zone. The wet membrane 25 may be stretched in a width direction by using the tenter drier 64. It is preferable that the wet membrane 25 is stretched in the casting direction and/or the width direction in the transfer section 101 and/or the tenter drier 64 such that a size of the wet membrane 25 after the stretching becomes 100.5% to 300% of the size of the same before the stretching.

After the wet membrane 25 is dried by the tenter drier 64 until the remaining solvent amount reaches a predetermined value, the wet membrane 25 is sent to the edge slitting device 67 as the membrane 62. Both side edges of the membrane 62 are cut off by the edge slitting device 67. The cut edges are sent to the crusher 103 by a cutter blower (not shown). The membrane edges are shredded by the crusher 103 and become chips. The chip is recycled for preparing the dope, and this enables effective use of the raw material. The slitting process for the membrane edges may be omitted. However, it is preferable to perform the slitting process between the casting process and the membrane winding process.

Meanwhile, the membrane 62 of which both side edges have been cut off is sent to the drying chamber 69 and is further dried. Although a temperature of the drying chamber 69 is not especially limited, it is determined in accordance with heat resistance properties (glass transition point Tg, heat deflection temperature under load, melting point Tm, continuous-use temperature and the like) of the solid electrolyte, and the temperature is preferably Tg or lower. In the drying chamber 69, the membrane 62 is carried while being bridged across the rollers 68, and the solvent gas vaporized therein is absorbed and recovered by the absorbing device 106. The air from which the solvent vapor is removed is sent again into the drying chamber 69 as the dry air. Incidentally, it is preferable that the drying chamber 69 is divided into a plurality of regions for the purpose of changing the sending air temperature. Meanwhile, in a case that a preliminary drying chamber (not shown) is provided between the edge slitting device 67 and the drying chamber 69 to preliminarily dry the membrane 62, a membrane temperature is prevented from rapidly increasing in the drying chamber 69. Thus, in this case, it is possible to prevent a shape of the membrane 62 from changing.

The membrane 62 is cooled in the cooling chamber 71 until the membrane temperature becomes about a room temperature. A moisture control chamber (not shown) may be provided between the drying chamber 69 and the cooling chamber 71. Preferably, air having desirable humidity and temperature is applied to the membrane 62 in the moisture control chamber. By doing so, it is possible to prevent the membrane 62 from curling and to prevent winding defect from occurring at the time of winding.

In the solution casting method, various steps such as the drying step, the edge slitting step and so forth are performed over the wet membrane or the membrane (solid electrolyte membrane) after the wet membrane is peeled from the support and until the membrane is wound up. During or between each step, the wet membrane or the membrane is mainly supported or transported by the rollers. Among these rollers, some are drive rollers and others are non-drive rollers. The non-drive rollers are used for determining a membrane passage, and at the same time for improving transport stability of the membrane.

While the membrane 62 is carried, the charged voltage thereof is kept in the predetermined range. The charged voltage is preferably at −3 kV to +3 kV after the neutralization. Further, it is preferable that the knurling is formed on the membrane 62 by the knurling roller pair 73. Incidentally, it is preferable that asperity height of the knurling portion is 1 μm to 200 μm.

The membrane 62 is wound up by the winding roller 107 contained in the winding chamber 76. At this time, it is preferable to wind the membrane 62 in a state that a desirable tension is given by the press roller 108. Preferably, the tension is gradually changed from the start of winding to the end thereof. Owing to this, the membrane 62 is prevented from being wound excessively tightly. It is preferable that a width of the membrane 62 to be wound up is not less than 100 mm. The present invention is applicable to a case in that a thin membrane of which thickness is 5 μm or more and 300 μm or less is produced.

In the present invention, a simultaneous co-casting method or a sequential co-casting method can be performed to cast two or more sorts of dopes. When the simultaneous co-casting is performed, a feed block may be attached to the casting die, or a multi-manifold type casting die may be used. A thickness of at least one surface layer, which is exposed to outside, of a multi-layered membrane is preferably in the range of 0.5% to 30% to the total thickness of the membrane. Moreover, in the simultaneous co-casting method, it is preferable to preliminary adjust each dope's viscosity such that the lower viscosity dopes entirely cover over the higher viscosity dope when the dopes are cast onto the support from the die slit. Furthermore, in the simultaneous co-casting method, it is preferable that the inner dope is covered with dopes whose poor solvent ratio is larger than that of the inner dope in the bead, which is formed between the die slit and the support.

Instead of the above-described method for forming the solid electrolyte into a membrane, it is possible to infiltrate the solid electrolyte into micropores of a so-called porous substrate in order to produce different type of the solid electrolyte membrane. As such method of producing the solid electrolyte membrane, there are a method in which a sol-gel reaction liquid containing the solid electrolyte is applied to the porous substrate so that the sol-gel reaction liquid is infiltrated into the micropores thereof, a method in which such porous substrate is dipped in the sol-gel reaction liquid containing the solid electrolyte to thereby fill the micropores with the solid electrolyte, and the like. Preferred examples of the porous substrate are porous polypropylene, porous polytetrafluoroethylene, porous cross-linked heat-resistant polyethylene, porous polyimide, and the like. Additionally, it is also possible to process the solid electrolyte into a fiber form and fill spaces therein with other polymer compounds, and forms this fiber into a membrane to produce the solid electrolyte membrane. In this case, for example, those used as the additives in the present invention may be used as the polymer compounds to fill the spaces.

The solid electrolyte membrane of the present invention is appropriately used for the fuel cell, especially as a proton conducting membrane for a direct methanol fuel cell. Besides that, the solid electrolyte membrane of the present invention is used as a solid electrolyte membrane interposed between the two electrodes of the fuel cell. Moreover, the solid electrolyte membrane of the present invention is used as an electrolyte for various cells (redox flow cell, lithium cell, and the like), a display element, an electrochemical censor, a signal transfer medium, a condenser, an electrodialysis, an electrolyte membrane for electrolysis, a gel actuator, a salt electrolyte membrane, a proton-exchange resin, and the like.

(Fuel Cell)

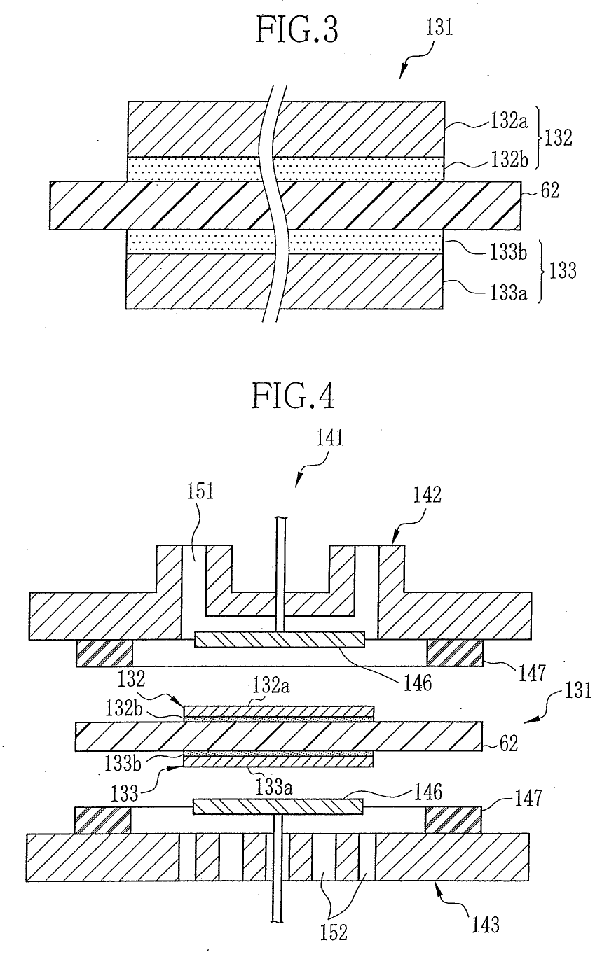

Hereinafter, an example of using the solid electrolyte membrane in a Membrane Electrode Assembly (hereinafter, MEA) and an example of using this MEA in a fuel cell are explained. Note, however, that forms of the MEA and the fuel cell described here are just an example and the present invention is not limited to them. In FIG. 3, a MEA 131 has the membrane 62 and an anode 132 and a cathode 133 opposing each other. The membrane 62 is interposed between the anode 132 and the cathode 133.

The anode 132 has a porous conductive sheet 132a and a catalyst layer 132b contacting the membrane 62, whereas the cathode 133 has a porous conductive sheet 133a and a catalyst layer 133b contacting the membrane 62. As the porous conductive sheets 132a and 133a, there are a carbon sheet and the like. The catalyst layers 132b and 133b are made of a dispersed substance in which catalyst metal-supporting carbon particles are dispersed in the proton conducting material. As the catalyst metal, there are platinum and the like. As the carbon particles, there are, for example, ketjenblack, acetylene black, carbon nanotube (CNT) and the like. As the proton conducting material, there are, for example, Nafion (registered trademark) and the like.

As a method of producing the MEA 131, the following four methods are preferable.

(1) Proton conducting material coating method: A catalyst paste (ink) that has an active metal-supporting carbon, a proton conducting material and a solvent is directly applied onto both surfaces of the membrane 62, and the porous conductive sheets 132a and 133a are (thermally) adhered under pressure thereto to form a five-layered MEA.

(2) Porous conductive sheet coating method: A liquid containing the materials of the catalyst layers 132b and 133b, that is, for example the catalyst paste is applied onto the porous conductive sheets 132a and 133a to form the catalyst layers 132b and 133b thereon, and the membrane 62 is adhered thereto under pressure to form a five-layered MEA.

(3) Decal method: The catalyst paste is applied onto polytetrafluoroethylene (PTFE) to form the catalyst layers 132b and 133b thereon, and the catalyst layers 132b and 133b alone are transferred to the membrane 62 to form a three-layer structure. The porous conductive sheets 132a and 133a are adhered thereto under pressure to form a five-layered MEA.

(4) Catalyst post-attachment method: Ink prepared by mixing a carbon material not supporting platinum and the proton conducting material is applied onto the membrane 62, the porous conductive sheet 132a and 133a or the PTFE to form a membrane. After that, the membrane is impregnated with liquid containing platinum ions, and platinum particles are precipitated in the membrane through reduction to thereby form the catalyst layers 132b and 133b. After the catalyst layers 132b and 133b are formed, the MEA 131 is formed according to one of the above-described methods (1) to (3).

Note that the method of producing the MEA is not limited to the above-described methods, but various well-known methods are applicable. Besides the methods (1) to (4), there is, for example, the following method. A coating liquid containing the materials of the catalyst layers 132b and 133b is previously prepared. The coating liquid is applied onto supports and dried. The supports having the catalyst layers 132b and 133b formed thereon are adhered so as to contact with both surfaces of the membrane 62 under pressure. After peeling the supports therefrom, the membrane 62 having the catalyst layers 132b and 133b on both surfaces is interposed by the porous conductive sheets 132a and 133a. The porous conductive sheets 132a and 133a and the catalyst layers 132b and 133b are tightly adhered to form a MEA 131.

In FIG. 4, a fuel cell 141 has the MEA 131, a pair of separators 142, 143 holding the MEA 131 therebetween, current collectors 146 made of a stainless net attached to the separators 142, 143, and gaskets 147. The fuel cell 141 is illustrated in exploded fashion in FIG. 4 for the sake of convenience of explanation, however, each element of the fuel cell 141 are adhered to each other to be used as a fuel cell. The anode-side separator 142 has an anode-side opening 151 formed through it; and the cathode-side separator 143 has a cathode-side opening 152 formed through it. Vapor fuel such as hydrogen or alcohol (methanol and the like) or liquid fuel such as aqueous alcohol solution is fed to the cell via the anode-side opening 151; and an oxidizing gas such as oxygen gas or air is fed thereto via the cathode-side opening 152.

For the anode 132 and the cathode 133, for example, a catalyst that supports active metal particles of platinum or the like on a carbon material may be used. The particle size of the active metal particles that are generally used in the art is from 2 nm to 10 nm. Active metal particles having a smaller particle size may have a larger surface area per the unit weight thereof, and are therefore more advantageous since their activity is higher. If too small, however, the particles are difficult to disperse with no aggregation, and it is said that the lowermost limit of the particle size will be 2 nm or so.

In hydrogen-oxygen fuel cells, the active polarization of cathode, namely air electrode is higher than that of anode, namely hydrogen electrode. This is because the cathode reaction, namely oxygen reduction is slow as compared with the anode reaction. For enhancing the oxygen electrode activity, usable are various platinum-based binary alloys such as Pt—Cr, Pt—Ni, Pt—Co, Pt—Cu, Pt—Fe. In a direct methanol fuel cell in which aqueous methanol is used for the anode fuel, usable are platinum-based binary alloys such as Pt—Ru, Pt—Fe, Pt—Ni, Pt—Co, Pt—Mo, and platinum-based ternary alloys such as Pt—Ru—Mo, Pt—Ru—W, Pt—Ru—Co, Pt—Ru—Fe, Pt—Ru—Ni, Pt—Ru—Cu, Pt—Ru—Sn, Pt—Ru—Au in order to inhibit the catalyst Poisoning with CO that is formed during methanol oxidation. For the carbon material that supports the active metal thereon, preferred are acetylene black, Vulcan XC-72, ketjenblack, carbon nanohorn (CNH) and CNT.

The function of the catalyst layers 132b, 133b includes (1) transporting fuel to active metal, (2) providing the reaction site for oxidation of fuel (anode) or for reduction of fuel (cathode), (3) transmitting the electrons released in the redox reaction to the current collector 146, and (4) transporting the protons generated in the reaction to the solid electrolyte, namely the membrane 62. For (1), the catalyst layers 132b, 133b must be porous so that liquid and vapor fuel may penetrate into the depth thereof. The catalyst supporting active metal particles on a carbon material works for (2); and the carbon material works for (3). For attaining the function of (4), the catalyst layers 132b, 133b contain a proton conducting material added thereto. The proton conducting material to be in the catalyst layers 132b, 133b is not specifically defined as long as it is a solid that has a proton-donating group. The proton conducting material may preferably be acid residue-having polymer compounds that are used for the membrane 62 such as perfluorosulfonic acids, as typified by Nafion (registered trademark); poly(meth)acrylate having a phosphoric acid group in side chains; sulfonated heat-resistant aromatic polymers such as sulfonated polyether etherketones and sulfonated polybenzimidazoles. When the solid electrolyte for the membrane 62 is used for the catalyst layers 132b, 133b, the membrane 62 and the catalyst layers 132b, 133b are formed of a material of the same type. As a result, the electrochemical adhesiveness between the solid electrolyte and catalyst layer becomes high. Accordingly, this is advantageous in terms of the ionic conductivity. The amount of the active metal to be used herein is preferably from 0.03 mg/cm² to 10 mg/cm² in view of the cell output and economic efficiency. The amount of the carbon material that supports the active metal is preferably from 1 to 10 times the weight of the active metal. The amount of the proton conducting material is preferably from 0.1 to 0.7 times the weight of the active metal-supporting carbon.

The anode 132 and the cathode 133 act as current collectors (power collectors) and also act to prevent water from staying therein to worsen vapor permeation. In general, carbon paper or carbon cloth may be used. If desired, the carbon paper or the carbon cloth may be processed with PTFE so as to be repellent to water.

The MEA has a value of area resistance preferably at 3 Ωcm² or less, more preferably at 1 Ωcm² or less, and most preferably at 0.5 Ωcm² or less according to alternating-current (AC) impedance method in a state that the MEA is incorporated in a cell and the cell is filled with fuel. The area resistance value is calculated by a product of the measured resistance value and a sample area.

Fuel for fuel cells is described. For anode fuel, usable are hydrogen, alcohols (methanol, isopropanol, ethylene glycol and the like), ethers (dimethyl ether, dimethoxymethane, trimethoxymethane and the like), formic acid, boronhydride complexes, ascorbic acid, and so forth. For cathode fuel, usable are oxygen (including oxygen in air), hydrogen peroxide, and so forth.

In direct methanol fuel cells, the anode fuel may be aqueous methanol having a methanol concentration of 3 wt. % to 64 wt. %. As in the anode reaction formula (CH₃OH+H₂O→CO₂+6H⁺+6e⁻), 1 mol of methanol requires 1 mol of water, and the methanol concentration at this time corresponds to 64 wt. %. A higher methanol concentration in fuel is more effective for reducing the weight and the volume of the cell including a fuel tank of the same energy capacity. However, if the methanol concentration is too high, much methanol may penetrate through the solid electrolyte to reach the cathode on which it reacts with oxygen to lower the voltage. This is so-called the crossover phenomenon. When the methanol concentration is too high, the crossover phenomenon is remarkable and the cell output tends to lower. In view of this, the optimum concentration of methanol shall be determined depending on the methanol perviousness through the solid electrolyte used. The cathode reaction formula in direct methanol fuel cells is ( 3/2) O₂+6H⁺+6e⁻→H₂O, and oxygen (generally, oxygen in air) is used for the fuel in the cells.

For supplying the anode fuel and the cathode fuel to the respective catalyst layers 132b and 133b, there are two applicable methods: (1) a method of forcedly sending the fuel by the use of an auxiliary device such as pump (active method), and (2) a method not using such an auxiliary device, in which liquid fuel is supplied through capillarity or by spontaneously dropping it, and vapor fuel is supplied by exposing the catalyst layer to air (passive method). It is also possible to combine the methods (1) and (2). In the method (1), high-concentration methanol is usable as fuel and air supply enables high output from the cells by extracting water formed in the cathode area. These are the advantages of the method (1). However, this method has the disadvantage in that the necessary fuel supply unit will make it difficult to downsize the cells. On the other hand, the advantage of the method (2) is capability of downsizing the cells, but the disadvantage thereof is that the fuel supply rate is readily limited and high output from the cells is often difficult.

Unit cell voltage of fuel cells is generally at most 1 V. Therefore, the unit cells are stacked up in series depending on the necessary voltage for load. For cell stacking, employable methods are a method of “plane stacking” that arranges the unit cells on a plane, and a method of “bipolar stacking” that stacks up the unit cells via a separator with a fuel pathway formed on both sides thereof. In the plane stacking, the cathode (air electrode) is on the surface of the stacked structure and therefore it readily takes air thereinto. In addition, since the stacked structure may be thinned, it is more favorable for small-sized fuel cells. Besides the above-described methods, MEMS technology may be employed, in which a silicon wafer is processed to form a micropattern and fuel cells are stacked thereon.

Fuel cells may have many applications for automobiles, electric and electronic appliances for household use, mobile devices, portable devices, and the like. In particular, direct methanol fuel cells can be downsized, the weight thereof can be reduced and do not require charging. Having such many advantages, they are expected to be used for various energy sources for mobile appliances and portable appliances. For example, mobile appliances in which fuel cells are favorably used include mobile phones, mobile notebook-size personal computers, electronic still cameras, PDA, video cameras, mobile game machines, mobile servers, wearable personal computers, mobile displays and the like. Portable appliances in which fuel cells are favorably used include portable generators, outdoor lighting devices, pocket lamps, electrically-powered (or assisted) bicycles and the like. In addition, fuel cells are also favorable for power sources for robots for industrial and household use and for other toys. Moreover, they are further usable as power sources for charging secondary batteries that are mounted on these appliances.

### EXAMPLE 1

Hereinafter, examples of the present invention are explained. In the following description, Example 1 is explained in detail. With respect to Examples 2 to 8, conditions different from the Example 1 are only explained. Note that Examples 1 to 3, 7 and 8 are the embodiments of the present invention, and Examples 4 to 6 are the comparative experiments of Examples 1 to 3.

A material A was flash-concentrated by the flash device 26 and dried. The dried material A and the solvent were mixed by the following composition and the solid contents in the material A was dissolved into the solvent. In this way, the dope 24 having 20 wt. % of the solid electrolyte was produced. The dope 24 is hereinafter referred to as a dope A. Note that the material A was 20% Nafion (registered trademark) Dispersion Solution DE2020 (manufactured by US Dupont).

| | |
|---|---|
| Dried material A | 100 pts. wt |
| Solvent (Perfluorohexane) | 400 pts. wt |

[Production of Solid Electrolyte Membrane 62]

The dope A was cast onto the running belt 82 from the casting die 81 so as to form the casting membrane 24a. The dry air of 30° C. to 50° C. was applied to the casting membrane 24a by the air blowers 91, 92 and 93 so as to dry the casting membrane 24 until the solvent content thereof reached 30 wt. % with respect to the solid contents of the material A, namely the solid electrolyte. After the casting membrane 24a had possessed a self-supporting property, the casting membrane 24a was peeled from the belt 82 as the wet membrane 25. The peeled wet membrane 25 contained the solvent. The wet membrane 25 was fed into the tenter drier 64 and transported therein in a state that both side edges thereof were held with the clips 64a. In the tenter drier 64, the wet membrane 25 was dried until the solvent content thereof reached 15 wt. % with respect to the solid contents by the dry air of 50° C. The wet membrane 25 was then released from the clips 64a at an exit of the tenter drier 64 as the membrane 62. Both side edges of the membrane 62, which had been held by the clips 64a, were cut off by the edge slitting device 67 disposed downstream from the tenter drier 64. The membrane 62 of which both side edges had been cut off was sent to the drying chamber 69 and was further dried at the temperature of 50° C. to 70° C. while transported by the rollers 68. In this way, the solid electrolyte membrane 62 having the solvent content of less than 3 wt. % was obtained.

The obtained membrane 62 was evaluated in each of the following items. Evaluation results are shown in Table 1. Note that the number of the evaluation items in Table 1 correspond to the number assigned to each of the following items.

1. Thickness

Thickness of the membrane 62 was continuously measured at a speed of 600 mm/min. by the use of an electronic micrometer manufactured by Anritsu Electric Co., Ltd. Data obtained by the measurement was recorded on a chart on a scale of 1/20, at a chart speed of 30 mm/min. After obtaining measurements of data curve by a ruler, an average thickness value of the membrane 62 and thickness unevenness relative to the average thickness value were obtained based on the obtained measurements. In Table 1, (a) represents the average thickness value (unit: μm) and (b) represents the thickness unevenness (unit: μm) relative to (a).

2. Number of Defect

Defects such as deformation were detected by illuminating the membrane 62 at full width×1 m thereof and looking at the reflected light therefrom. Parts detected as the defects by looking were then observed with a polarizing microscope, and number of the defects was counted per 1 mm². Note that the deformation like scratches caused after the detection were not counted.

3. Ionic Conductivity Coefficient

On the obtained solid electrolyte membrane 62, ten measurement points each of which is 1 m apart from one another were selected along a longitudinal direction of the membrane 62. These ten measurement points were cut out into circular sample having a diameter of 13 mm. Each sample was interposed by a pair of stainless plates, and the ionic conductivity coefficient of the sample was measured in accordance with the AC impedance method by the use of a Multichannel Battery Test System 1470 and 1255B manufactured by Solartron Co., Ltd. The measurement was performed under the condition of a temperature at 80° C. and a relative humidity of 95%. The ionic conductivity is represented by a value of the AC impedance (unit: S/cm) as shown in Table 1.

4. Output Density of Fuel Cell 141

The fuel cell 141 using the membrane 62 was formed, and output thereof was measured. According to the following methods, the fuel cell 141 was formed, and the output density thereof was measured.

(1) Formation of Catalyst Sheet A as Catalyst Layers 132b, 133b

2 g of platinum-supporting carbon was mixed with 15 g of the solid electrolyte (5% DMF solution), and dispersed for 30 minutes with an ultrasonic disperser. The mean particle size of the resulting dispersion was about 500 nm. The dispersion was applied onto a carbon paper having a thickness of 350 μm and dried, and a circular disc having a diameter of 9 mm was blanked out of it. This is catalyst sheet A. Note that the above-mentioned platinum-supporting carbon was Vulcan XC72 with 50 wt. % of platinum, and the solid electrolyte was same as those used for producing the membrane 62.

(2) Formation of MEA 131

The catalyst sheet A was attached to both surfaces of the solid electrolyte membrane 62 in such a manner that the coated face of the catalyst sheet A was contacted with the membrane 62, and thermally adhered for 2 minutes at a temperature of 80° C. under a pressure of 3 MPa. In this way, a MEA 131 was formed.

(3) Output Density of Fuel Cell 141

The MEA fabricated in (2) was set in a fuel cell as shown in FIG. 4, and an aqueous 15 wt. % methanol solution was fed into the cell via the anode-side opening 151. At this time, the cathode-side opening 152 was kept open to air. The anode 132 and the cathode 133 were connected to the Multichannel Battery Test System (Solartron 1470), and the output density (unit: W/cm²) was measured.

### EXAMPLE 2

A material B and the solvent were mixed by the following composition and the solid contents in the material B was dissolved into the solvent. In this way, the dope 24 having 20 wt. % of the solid electrolyte was produced. The dope 24 is hereinafter referred to as a dope B. Note that the material B was sulfonated polyacrylonitrile butadiene styrene with a sulfonation rate of 35%.

| | |
|---|---|
| Material B | 100 pts. wt |
| Solvent (N,N-dimethylformamide) | 400 pts. wt |

Note that the material B was synthesized in accordance with the following synthetic methods.

### (1) Synthesis of 4-(4-(4-pentylcyclohexyl)phenoxymethyl)styrene

Substances of the compositions as shown below were reacted at 100° C. for 7 hours, and the obtained reaction liquid was cooled to reach a room temperature. After that, water was added to the reaction liquid so as to generate 4-(4-(4-pentylcyclohexyl)pheno xymethyl)styrene as a crystal. After the filtration of the liquid, the crystal was purified by an aqueous solution of water/acetonictrile (1:1), and air-dried. In this way, 4-(4-(4-pentylcyclohexyl)phenoxymethyl)styrene was obtained.

| | |
|---|---|
| 4-(4-pentylcyclohexyl) phenol | 14 pts. wt |
| 4-chloromethylstyrene | 9 pts. wt |
| Potassium carbonate | 11 pts. wt |
| N,N-dimethylformamide | 66 pts. wt |

### (2) Synthesis of Graft Copolymer

A mixture having a composition as shown below was heated to reach 60° C.

| | |
|---|---|
| Polybutadiene latex | 100 pts. wt |
| Potassium rosinate | 0.83 pts. wt |
| Dextrose | 0.50 pts. wt |
| Sodium pyrophosphate | 0.17 pts. wt |
| Ferrous sulfate | 0.08 pts. wt |
| Water | 250 pts. wt |

After that, a mixture having a composition as shown below was delivered by drops into the above-described mixture for 60 minutes so as to perform polymerization reaction.

| | |
|---|---|
| Acrylonitrile | 21 pts. wt |
| 4-(4-(4-pentylcyclohexyl)phenoxymethyl)styrene | 62 pts. wt |
| t-dodecyl thiol | 0.5 pts. wt |
| cumene hydroperoxide | 3.0 pts. wt |

After the dropwise addition had completed, 0.2 pts.wt of cumene hydroperoxide was added thereto, and cooled for 1 hour. In this way, latex was obtained. The obtained latex was fed into a 1% sulfuric acid of 60° C., and heated up to 90° C. to be coagulated. The latex was then washed well with water and dried. In this way, graft copolymer was obtained.

### (3) Synthesis of Material B by sulfonation of Graft Copolymer

100 pts.wt of the graft copolymer synthesized in (2) was dissolved into 1300 pts.wt of dichloromethane. While the obtained liquid was maintained at 0° C. or lower, 13 pts.wt of concentrated sulfuric acid was slowly added thereto. The mixture was stirred for 6 hours so as to cause a precipitation. After the solvent was removed therefrom, the precipitation was dried. In this way, sulfonated polyacrylonitrile butadiene styrene as the material B was obtained. Introduction rate of a sulfonic acid group by the dropwise addition was 35%.

[Production of Solid Electrolyte Membrane 62]

The dry air applied by the air blowers 91, 92 and 93 was set at 80° C. to 120° C. The dry air in the tenter drier 64 was set at 140° C. The membrane 62 of which both side edges had been cut off was dried at the temperature of 140° C. to 160° C. In this way, a solid electrolyte membrane 62 having the solvent content of less than 3 wt. % was obtained. Evaluation results of the obtained membrane 62 are shown in Table 1.

### EXAMPLE 3

A material C and the solvent ware mixed by the following composition and the solid contents in the material C was dissolved into the solvent. In this way, the dope 24 having 20 wt. % of the solid electrolyte was produced. The dope 24 is hereinafter referred to as a dope C. Note that the material C was sulfopropylationed polyether sulfone with a sulfonation rate of 35%, and it was produced in accordance with the synthetic method disclosed in Japanese Patent Laid-Open Publication No. 2002-110174.

| | |
|---|---|
| Material C | 100 pts. wt |
| Solvent (N-methylpyrrolidone) | 400 pts. wt |

[Production of Solid Electrolyte Membrane 62]

The dry air applied by the air blowers 91, 92 and 93 was set at 80° C. to 140° C. The dry air in the tenter drier 94 was set at 160° C. The membrane 62 of which both side edges had been cut off was dried at the temperature of 160° C. to 180° C. In this way, a solid electrolyte membrane 62 having the solvent content of less than 3 wt. % was obtained. Evaluation results of the obtained membrane 62 are shown in Table 1.

### EXAMPLE 4

### Production of Solid Electrolyte Membrane

The dope A was cast onto a glass, and a casting membrane on the glass was dried in an oven whose inside temperature was 80° C. After solvent content of the casting membrane had become less than 30 wt. % to the weight of the solid electrolyte, it was peeled from the glass as a membrane. The membrane was then dried in the oven at 120° C. while four sides thereof were retained by a frame member. Evaluation results of the obtained membrane are shown in Table 1.

### EXAMPLE 5

### Production of Solid Electrolyte Membrane

The dope B was cast onto a glass, and a casting membrane on the glass was dried in an oven whose inside temperature was 100° C. After solvent content of the casting membrane had become less than 30 wt. % to the weight of the solid electrolyte, it was peeled from the glass as a membrane. The membrane was then dried in the oven at 140° C. while four sides thereof were retained by a frame member. Evaluation results of the obtained membrane are shown in Table 1.

### EXAMPLE 6

The dope C was cast onto a glass, and a casting membrane on the glass was dried in an oven whose inside temperature was 140° C. After solvent content of the casting membrane had become less than 30 wt. % to the weight of the solid electrolyte, it was peeled from the glass as a membrane. The membrane was then dried in the oven at 180° C. while four sides thereof were retained by a frame member. Evaluation results of the obtained membrane are shown in Table 1.

### EXAMPLE 7

A compound represented by the chemical formula 1 was used as the solid electrolyte. Note that protonation for obtaining the compound represented by the chemical formula 1, namely acid treatment was not performed before dope production, but during the dope production as described below. Non-protonated compound of the chemical formula 1, namely a precursor of the solid electrolyte was a material D. The material D was dissolved into the solvent to be a dope for casting. The method of producing the dope is same as the method of producing the dope 24 in Example 1. The solvent was a mixture of the solvent ingredients 1 and 2. The solvent ingredient 1 was a good solvent of the material D, and the solvent ingredient 2 was a poor solvent of the material D. In Example 7, X was Na, Y was SO₂ and Z had a structure shown as (I) of the chemical formula 2, and n was 0.33 and m was 0.67 in the chemical formula 1. Number average molecule weight Mn was 61000 and weight average molecular weight Mw was 159000.

| | |
|---|---|
| Material D | 100 pts. wt |
| Solvent ingredient 1 (dimethylsulfoxide) | 256 pts. wt |
| Solvent ingredient 2 (methanol) | 171 pts. wt |

A membrane formed by casting the dope on the belt 82 and peeled therefrom was made from the material D, so it is referred to as a precursor membrane. After going through the steps same as Example 1, the precursor membrane of which both side edges had been cut off was protonated by acid treatment and fed into a cleansing step. The acid treatment is a step to bring the precursor membrane into contact with an acid aqueous solution. Owing to this acid treatment, the precursor came to have the structure represented by the chemical formula 1, which is the solid electrolyte. The contact was made by soaking the membrane made from the solid electrolyte into a tank sequentially supplied with the acid aqueous solution. The cleansing after the acid treatment was performed with water. The membrane 62 after the cleansing step was sent to the drying chamber 69. Evaluation results of the obtained membrane 62 are shown in Table 1.

### EXAMPLE 8

A compound represented by the chemical formula 1, but different from the compound of the Example 7 was used as the solid electrolyte. Note that protonation for obtaining the compound represented by the chemical formula 1 was not performed before dope production, but during the dope production as well as Example 7. A precursor used as a dope ingredient was a material E. The solvent was a mixture of the solvent ingredients 1 and 2 as shown below. The solvent ingredient 1 was a good solvent of the material E, and the solvent ingredient 2 was a poor solvent of the material E. In Example 8, X was Na, Y was SO₂ and Z had a structure shown as (I) and (II) of the chemical formula 2, and n was 0.33 and m was 0.67. Number average molecule weight Mn was 68000 and weight average molecular weight Mw was 200000 in the chemical formula 1. In the chemical formula 2, (I) was 0.7 mol % and (II) was 0.3 mol %. Besides that, conditions are same as Example 7.

| | |
|---|---|
| Material E | 100 pts. wt |
| Solvent ingredient 1 (dimethylsulfoxide) | 200 pts. wt |
| Solvent ingredient 2 (methanol) | 135 pts. wt |

TABLE 1

| | Evaluation Item | | | | |
|---|---|---|---|---|---|
| | | | 2 | | |
| | 1 (μm) | | (number/ | 3 | 4 |
| | (a) | (b) | m²) | (S/cm) | (W/cm²) |
| Example 1 | 54 | ±1.5 | 0.5 | 0.09-0.10 | 0.46-0.48 |
| Example 2 | 53 | ±1.6 | 0.3 | 0.08-0.09 | 0.44-0.48 |
| Example 3 | 54 | ±1.4 | 0.3 | 0.10-0.11 | 0.50-0.54 |
| Example 4 | 55 | ±3.1 | 5.7 | 0.09 | 0.47 |
| Example 5 | 52 | ±3.2 | 6.1 | 0.08 | 0.46 |
| Example 6 | 51 | ±3.0 | 10.1 | 0.10 | 0.51 |
| Example 7 | 53 | ±1.2 | 0.4 | 0.09-0.10 | 0.45-0.49 |
| Example 8 | 54 | ±1.5 | 0.3 | 0.09-0.10 | 0.46-0.48 |

From the results of the above-mentioned examples, it will be understood that it is possible to continuously produce the solid electrolyte membrane having excellent planarity and reduced defects according to the present invention. It will be also understood that the obtained solid electrolyte membrane can be suitably used as a solid electrolyte membrane for a fuel cell.

### INDUSTRIAL APPLICABILITY

The solid electrolyte membrane, the method and the apparatus of producing the same, the membrane electrode assembly and the fuel cell using the solid electrolyte membrane of the present invention are applicable to the power sources for various mobile appliances and various portable appliances.

1. A method of producing a solid electrolyte membrane, comprising the steps of:
casting a dope containing a solid electrolyte and an organic solvent from a casting die onto a running support so as to form a casting membrane;
peeling said casting membrane from said support as a wet membrane containing said organic solvent;
performing a first drying of said wet membrane in a state that both side edges thereof are held by holding devices; and
performing a second drying of said wet membrane supported by rollers to form said solid electrolyte membrane, said second drying step being performed after said first drying step.

2. A method described in claim 1, wherein a concentration of said solid electrolyte in said dope is 5 wt. % or more and 50 wt. % or less.

3. A method described in claim 1, wherein at least one of said first drying step and said second drying step of said wet membrane is performed by sending air to the vicinity of said wet membrane.

4. A method described in claim 1, wherein said casting membrane is dried by sending air to the vicinity of said casting membrane.

5. A method described in claim 1, wherein said organic solvent is a mixture of a poor solvent and a good solvent of said solid electrolyte.

6. A method described in claim 5, wherein a weight ratio of said poor solvent in said organic solvent is 10% or more and less than 100%.

7. A method described in claim 5, wherein said good solvent contains dimethylsulfoxide, whereas said poor solvent contains alcohol having 1 to 5 carbons.

8. A method described in claim 1, wherein said solid electrolyte is a hydrocarbon polymer.

9. A method described in claim 8, wherein said hydrocarbon polymer is an aromatic polymer having a sulfonic acid group.

10. A method described in claim 9, wherein said aromatic polymer is a copolymer composed from each structure unit represented as formulae (I), (II) and (III) of a chemical formula 1: 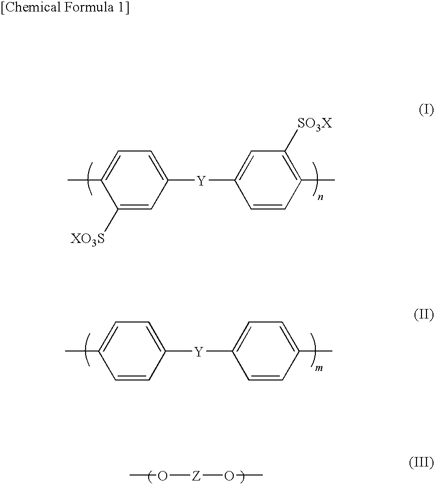
wherein, X is H, Y is SO₂ and Z has a structure shown as a formula (I) or (II) of a chemical formula 2, and n and m satisfy the following condition: 0.1≦n/(m+n)≦0.5.

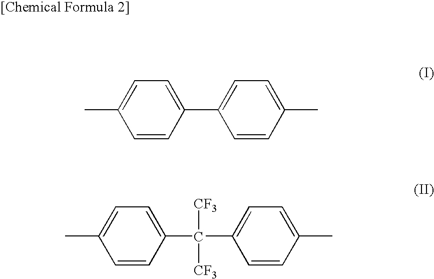

11. An apparatus of producing a solid electrolyte membrane, comprising:
a casting device for casting a dope containing a solid electrolyte and an organic solvent from a casting die onto a running support so as to form a casting membrane and peeling said casting membrane as a wet membrane containing said organic solvent;
a first drying device for drying said wet membrane in a state that both side edges thereof are held by holding devices; and
a second drying device for drying said wet membrane supported by rollers to form said solid electrolyte membrane, said second drying device being disposed downstream from said first drying device.

12. A solid electrolyte membrane produced by a method described in claim 1.

13. A membrane electrode assembly, comprising:
a solid electrolyte membrane described in claim 12;
an anode adhered to one surface of said solid electrolyte membrane, said anode generating protons from a hydrogen-containing material supplied from outside; and
a cathode adhered to the other surface of said solid electrolyte membrane, said cathode synthesizing water from said protons permeated through said solid electrolyte membrane and gas supplied from outside.

14. A fuel cell, comprising:
a membrane electrode assembly described in claim 13;
current collectors one of which provided in contact with said anode and the other of which provided in contact with said cathode, said current collector on said anode side receiving and passing electrons between said anode and outside, whereas said current collector on said cathode side receiving and passing said electrons between said cathode and outside.
